(19) United States
(12) Patent Application Publication
(10) Pub. No.: US 2014/0146766 A1
(43) Pub. Date: May 29, 2014

(54) METHOD AND APPARATUS FOR FACILITATING DISASTER COMMUNICATIONS

(71) Applicant: Nokia Corporation, Espoo (FI)

(72) Inventors: Niko Santeri Porjo, Piikkio (FI); Jakke Sakari Mäkelä, Turku (FI); Kalle Pietilä, Espoo (FI)

(73) Assignee: Nokia Corporation, Espoo (FI)

(21) Appl. No.: 14/119,970

(22) PCT Filed: May 25, 2011
(86) PCT No.: PCT/IB2011/052285

§ 371 Date: Nov. 25, 2013

(51) Int. Cl. H04W 76/00

(52) U.S. Cl. CPC H04W 76/007
USPC 370/329

(57) ABSTRACT

A method and apparatus are provided for facilitating disaster communications. A method may include prioritizing at least one message at a first node operating in a disaster communication mode in accordance with a message prioritization scheme associated with the disaster communication mode. The method may further include selecting a message from the at least one prioritized message based at least in part on the prioritization. The method may additionally include causing the selected message to be sent to a further node via an ad hoc connection. A corresponding apparatus is also provided. LEGAL02/32653987v

### TECHNOLOGICAL FIELD

Example embodiments of the present invention relate generally to communications technology and, more particularly, relate to a method and apparatus for facilitating disaster communications.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

However, the ubiquity of and reliance on mobile communication devices and their supporting networks has led to a vulnerability in the event of a disaster or other event disrupting network communications. For example, a natural or manmade disaster may result in destruction of and/or loss of power to network infrastructure providing access to a structured communication network that may be used by mobile communication devices. In the event of such a disruption of network services during a disaster, mobile device users may be unable to utilize traditional communication networks and services to communicate with emergency authorities, family, or friends.

### BRIEF SUMMARY

A system, method, and apparatus are herein provided for facilitating disaster communications. Systems, methods, and apparatuses in accordance with various embodiments may provide several advantages to computing devices, computing device users, government entities, and the general public. For example, some example embodiments provide a disaster communication mode by which computing devices may forward messages by ad hoc communication links during a disaster or other event disrupting network service. Accordingly, through use of peer-to-peer, or swarm, communications, messages may be forwarded, or repeated, among peer nodes, thus increasing the chance of a message reaching a node capable of communicating outside of the disaster area where network service may not be affected. In this regard, such example embodiments may facilitate communication between individuals within a disaster area and friends, loved ones, and authorities outside of the disaster area. Further, such example embodiments may facilitate the dissemination of information within the disaster area, such that authorities may provide status updates, coordinate emergency services, and the like.

Some example embodiments further provide prioritization schemes for prioritizing messages at a node operating in disaster communication mode. The prioritization schemes of some example embodiments may reduce unnecessary retransmission of messages amongst devices in a disaster area. This reduction of unnecessary retransmission may prevent overwhelming transmission capacity of ad hoc networks that may be used for transmission of messages in disaster communication mode in accordance with some example embodiments. Further, prioritization of messages and attendant reduction of unnecessary retransmission of messages in accordance with some example embodiments may conserve power consumption by devices within the disaster area.

In a first example embodiment, a method is provided, which may comprise prioritizing at least one message at a first node operating in a disaster communication mode in accordance with a message prioritization scheme associated with the disaster communication mode. The method of this example embodiment may further comprise selecting a message from the at least one prioritized message based at least in part on the prioritization. The method of this example embodiment may additionally comprise causing the selected message to be sent to a further node via an ad hoc connection.

In another example embodiment, an apparatus comprising at least one processor and at least one memory storing computer program code is provided. The at least one memory and stored computer program code may be configured, with the at least one processor, to cause the apparatus of this example embodiment to at least prioritize at least one message at a first node operating in a disaster communication mode in accordance with a message prioritization scheme associated with the disaster communication mode. The at least one memory and stored computer program code may be configured, with the at least one processor, to further cause the apparatus of this example embodiment to select a message from the at least one prioritized message based at least in part on the prioritization. The at least one memory and stored computer program code may be configured, with the at least one processor, to also cause the apparatus of this example embodiment to cause the selected message to be sent to a further node via an ad hoc connection.

In yet another example embodiment, an apparatus is provided that may comprise means for prioritizing at least one message at a first node operating in a disaster communication mode in accordance with a message prioritization scheme associated with the disaster communication mode. The apparatus of this example embodiment may further comprise means for selecting a message from the at least one prioritized message based at least in part on the prioritization. The apparatus of this example embodiment may additionally comprise means for causing the selected message to be sent to a further node via an ad hoc connection.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates an example structured network system according to some example embodiments;

FIG. 2 illustrates ad hoc communication between nodes when network service is disrupted according to some example embodiments;

FIG. 3 is a schematic block diagram of a mobile terminal according to some example embodiments;

FIG. 4 illustrates a block diagram of an apparatus according to some example embodiments;

FIG. 5 illustrates an example message format according to some example embodiments;

FIG. 6 illustrates an example disaster communication scenario in accordance with some example embodiments;

FIG. 7 illustrates a flowchart according to an example method for facilitating disaster communications according to some example embodiments;

FIG. 8 illustrates a flowchart according to another example method for facilitating disaster communications according to some example embodiments; and

FIG. 9 illustrates a flowchart according to yet another example method for facilitating disaster communications according to some example embodiments.

### DETAILED DESCRIPTION

Some example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Examples of non-transitory computer-readable media include a floppy disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, a random access memory (RAM), a programmable read only memory (PROM), an erasable programmable read only memory (EPROM), a FLASH-EPROM, any other memory chip or cartridge, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Devices having communications capability may normally use the communications capability to communicate with designated compatible devices via a structured network infrastructure. For example, computers connected to the Internet may communicate with other Internet-connected computers, as well as routers, switches, and other apparatuses supporting the structured network infrastructure. Similarly, wireless communications devices may normally communicate between designated compatible devices over a structured network. For example, a mobile phone may communicate via a structured cellular network, which may include a base station and/or other supporting devices. As another example, a computer may connect to a wireless local area network (WLAN) using a compatible wireless router or other wireless network adapter.

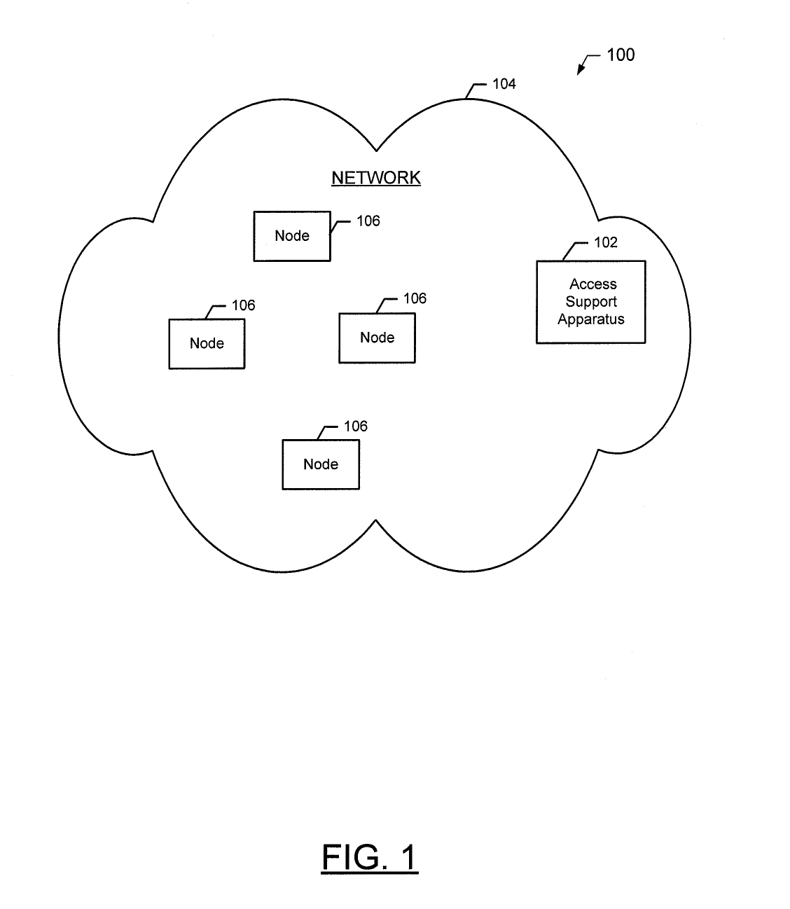

FIG. 1 illustrates an example structured network system 100 according to some example embodiments. It will be appreciated that the system 100 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a structured network system, embodiments of the invention may be implemented in other types of network systems.

The system 100 may include an access support apparatus 102, which may coordinate and/or otherwise support access to a network 104 by one or more nodes 106. The access support apparatus 102 may accordingly comprise any entity or combination of entities configured to provide access to and/or otherwise support operation of the network 104. By way of non-limiting example, the access support apparatus 102 may comprise a network access point, such as a router, wireless router, cellular base station, base transceiver station, node b, evolved node b (eNB), and/or the like. The access support apparatus 102 may, for example, additionally or alternatively comprise network back end infrastructure, such as a switch, hub, gateway (for example, cellular gateway), mobile switching center, and/or the like. As such, it will be appreciated that the access support apparatus 102 may be embodied as one or more servers, a server cluster, a cloud computing infrastructure, one or more desktop computers, one or more laptop computers, one or more network nodes, multiple computing devices in communication with each other, a chipset, an apparatus comprising a chipset, any combination thereof, and/or the like that may be configured to provide access to and/or otherwise support operation of the network 104. In some example embodiments, the access support apparatus 102 may be operated by a network operator or service provider, such as a cellular network provider, internet service provider (ISP), or the like.

The network 104 may comprise one or more wireless networks (for example, a cellular network, wireless local area network, wireless personal area network, wireless metropolitan area network, and/or the like), one or more wireline networks, or some combination thereof, and in some embodiments may comprise at least a portion of the internet.

A node 106 may be embodied as any computing device, such as, for example, a computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), peripheral device (for example, a Bluetooth peripheral device), a chipset, an apparatus comprising a chipset, any combination thereof, and/or the like. In this regard, a node 106 may comprise any device configured to communicate with another apparatus (for example, another node 106) via the network 104, an ad hoc network, an ad hoc communication link, and/or the like.

In some example embodiments, a node 106 may be configured to access the network 104 via the access support apparatus 102. In this regard, communications between nodes 106 on the network 104, as well as communications with other apparatuses that may be reached via the network 104 may be routed through and/or at least partially coordinated by the access support apparatus 102. Accordingly, in the event that the access support apparatus 102 goes down, such as due to malfunction, a power loss, destruction of the access support apparatus 102, and/or the like, access to the network 104 and/or services provided by the network 104 may be disrupted. For example, a disaster, such as a natural disaster (for example, an earthquake, tsunami, hurricane, tornado, storm, flood, or the like) or man-made disaster (for example, a terrorist attack, military action, or the like) may cause destruction of and/or a loss of power to the access support apparatus 102, resulting in a disruption of network service to the network 104.

Some example embodiments accordingly provide a disaster communication mode, which may facilitate communications (for example, disaster communications) among nodes 106 and/or other computing devices in the event network services are interrupted. It will be appreciated that unless otherwise noted, “disaster communication mode” and “disaster communications” are used to generally refer to a communications mode that may be implemented and communications that may be exchanged, respectively, in accordance with various example embodiments in the event of a disruption of network services. While such disruption of network services may be triggered by a natural or man-made disaster, it will be appreciated that example embodiments are not limited to implementation during a disaster. In this regard, unless specifically indicated otherwise, a disaster communication mode in accordance with various example embodiments may be implemented in response to any event that may cause a disruption of network access and/or services, such as may be provided by an access support apparatus 102.

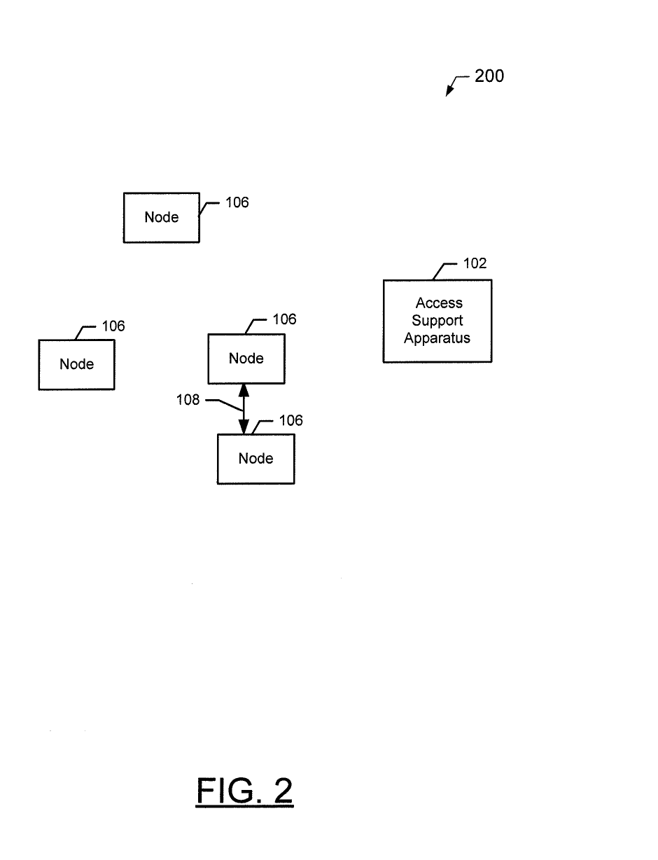

More particularly, some example embodiments provide a disaster communication mode, which may utilize ad hoc peer-to-peer (for example, swarm) communication to facilitate communication of messages via ad hoc connections. Referring now to FIG. 2, FIG. 2 illustrates ad hoc communication between nodes when network service is disrupted according to some example embodiments. In this regard, FIG. 2 illustrates a system 200, which may result in an instance in which a disaster or other event disrupts access to the network 104. For example, the access support apparatus 102 may suffer a malfunction, power loss, or the like, or may even be destroyed. Accordingly, the nodes 106 may be without access to the network 104 and/or services that may be provided by the network 104. However, in accordance with various example embodiments, the nodes 106 may be configured to operate in a disaster communication mode, in which ad hoc networks may be formed through one or more ad hoc connections between nodes to facilitate peer-to-peer communication of messages between nodes. In FIG. 2, one such ad hoc connection 108 by which a message may be exchanged between peer nodes is illustrated.

An ad hoc connection, such as the ad hoc connection 108, may, for example, comprise any ad hoc connection between nodes. By way of non-limiting example, an ad hoc connection may comprise a Bluetooth connection, radio frequency connection, Infrared Data Association (IrDA) connection, ZigBee connection, wireless universal serial bus (USB) connection, ultra wideband (UWB), Z-Wave connection, near field communication connection, infrared connection, WLAN connection, connection in accordance with any Institute of Electrical and Electronics Engineers (IEEE) 802.15 standard, and/or the like. In this regard, an ad hoc connection may comprise any connection that may be formed between nodes, such as when the nodes come within sufficient proximity of each other.

Two respective nodes may come “within sufficient proximity” of each other when their proximity is within range of a technology and/or communications hardware/software used for establishing an ad hoc connection between the nodes. Thus, for example, if a first node has a Bluetooth transmitter with a range of 10 meters, and Bluetooth is used for establishment of an ad hoc connection between the first node and a second node, “sufficient proximity” for establishment of the ad hoc connection may be interpreted as being 10 meters. As another example, two nodes may come within sufficient proximity of each other to establish an ad hoc connection when the first node detects the presence of the second node and/or when the second node detects the presence of the first node such that an ad hoc connection between the first and second nodes may be established. It will be appreciated that the proximity between two nodes when a presence of the proximate node is detected maybe less than a transmission/reception range of a technology and/or communication interface used for establishment of an ad hoc connection, such as due to operating conditions of a node, environmental conditions that may affect the range, and/or the like.

Such an ad hoc connection may be used by nodes to communicate with other types of nodes that might not be designated compatible devices with which a node, such as a node 106 would generally communicate or otherwise interface with when accessing a structured network, such as the network 104. For example, a node having Bluetooth communication capability may, in some example embodiments, be configured to establish an ad hoc Bluetooth connection with any Bluetooth device which the node encounters when operating in disaster communication mode.

In some example embodiments, ad hoc connections between nodes operating in a disaster communication mode may be used to exchange messages. Accordingly, disaster communication mode may facilitate forwarding, or repeating, messages in a peer-to-peer, or swarm fashion, which may facilitate communication within and beyond a disaster area (for example, the area in which network service has been disrupted). Messages that may be communicated in accordance with various example embodiments may, for example, include email messages, text messages, short message service (SMS) messages, multimedia messaging service (MMS) messages, voice messages, and/or the like. However, it will be appreciated that messages exchanged in accordance with various example embodiments are not limited to such message types, and may include any type of data or information that may be transmitted between nodes.

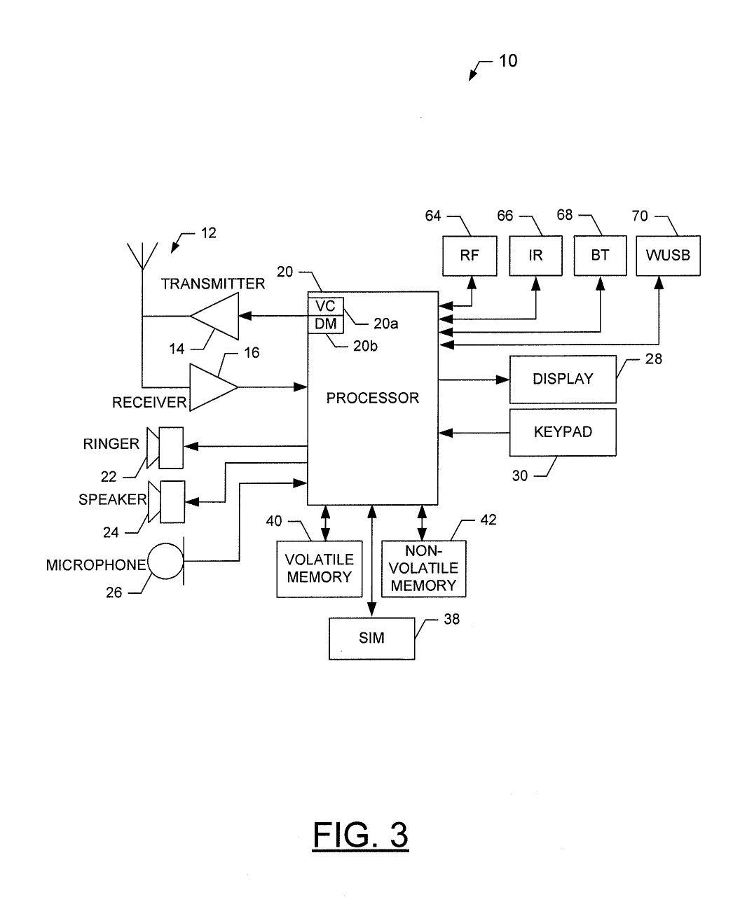

According to some example embodiments, a node, such as a node 106, which may be configured to implement a disaster communication mode in accordance with various example embodiments, may be embodied as a mobile terminal, such as that illustrated in FIG. 3. In this regard, FIG. 3 illustrates a block diagram of a mobile terminal 10 representative of some embodiments of a node, such as a node 106. It should be understood, however, that the mobile terminal 10 illustrated and hereinafter described is merely illustrative of one type of node that may implement and/or benefit from various embodiments and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some example embodiments the processor 20 may comprise a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). The mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display, a joystick, and/or other input device. In embodiments including a keypad, the keypad may comprise numeric (0-9) and related keys (#, *), and/or other keys for operating the mobile terminal.

As shown in FIG. 3, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. The mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

The mobile terminal 10 may comprise memory, such as a removable or non-removable subscriber identity module (SIM) 38, a soft SIM 38, a fixed SIM 38, a removable or non-removable universal subscriber identity module (USIM) 38, a soft USIM 38, a fixed USIM 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40, non-volatile memory 42 may also include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

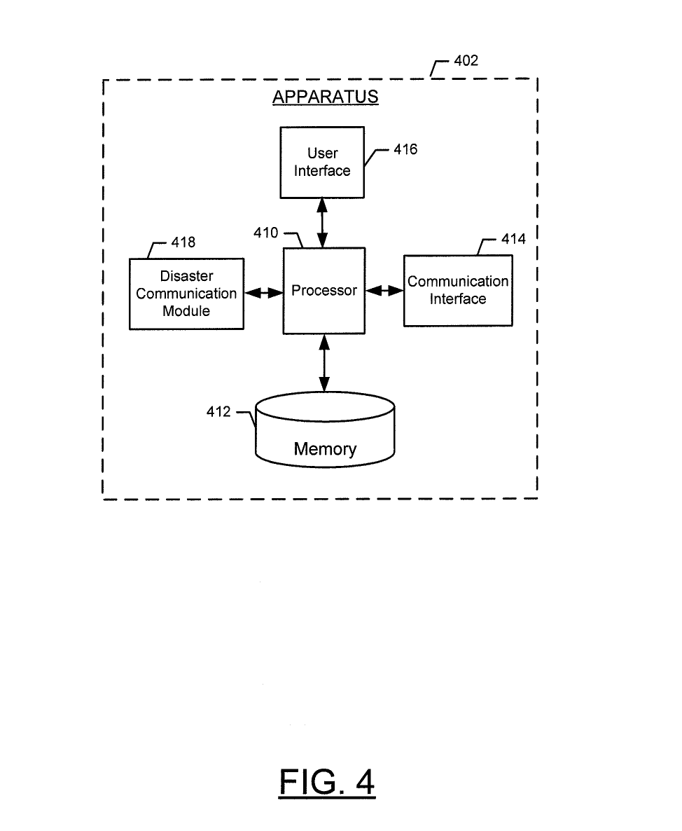

Referring now to FIG. 4, FIG. 4 illustrates a block diagram of an apparatus 402, which may be implemented on a node, such as a node 106 that may be configured to implement a disaster communication mode in accordance with some example embodiments. As such, by way of non-limiting example, the apparatus 402 may comprise or be implemented on a computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), peripheral device (for example, a Bluetooth peripheral device), a chipset, an apparatus comprising a chipset, any combination thereof, and/or the like.

In some example embodiments, the apparatus 402 may include various means for performing the various functions herein described. These means may comprise one or more of a processor 410, memory 412, communication interface 414, user interface 416, or disaster communication module 418. The means of the apparatus 402 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example memory 412) that is executable by a suitably configured processing device (for example, the processor 410), or some combination thereof.

In some example embodiments, one or more of the means illustrated in FIG. 4 may be embodied as a chip or chip set. In other words, the apparatus 402 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 410, memory 412, communication interface 414, user interface 416, and/or disaster communication module 418 may be embodied as a chip or chip set. The apparatus 402 may therefore, in some example embodiments, be configured to implement example embodiments of the present invention on a single chip or as a single “system on a chip.” As another example, in some example embodiments, the apparatus 402 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 410 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other hardware processors, or some combination thereof. Accordingly, although illustrated in FIG. 4 as a single processor, in some example embodiments the processor 410 may comprise a plurality of processors. The plurality of processors may be in operative communication with each other and may be collectively configured to perform one or more functionalities of the apparatus 402 as described herein. The plurality of processors may be embodied on a single computing device or distributed across a plurality of computing devices collectively configured to function as the apparatus 402. In embodiments wherein the apparatus 402 is embodied as a mobile terminal 10, the processor 410 may be embodied as or may comprise the processor 20. In some example embodiments, the processor 410 is configured to execute instructions stored in the memory 412 or otherwise accessible to the processor 410. These instructions, when executed by the processor 410, may cause the apparatus 402 to perform one or more of the functionalities of the apparatus 402 as described herein. As such, whether configured by hardware or software methods, or by a combination thereof, the processor 410 may comprise an entity capable of performing operations according to embodiments of the present invention while configured accordingly. Thus, for example, when the processor 410 is embodied as an ASIC, FPGA or the like, the processor 410 may comprise specifically configured hardware for conducting one or more operations described herein. Alternatively, as another example, when the processor 410 is embodied as an executor of instructions, such as may be stored in the memory 412, the instructions may specifically configure the processor 410 to perform one or more algorithms and operations described herein.

The memory 412 may comprise, for example, volatile memory, non-volatile memory, or some combination thereof. In this regard, the memory 412 may comprise one or more non-transitory computer-readable storage mediums. Although illustrated in FIG. 4 as a single memory, the memory 412 may comprise a plurality of memories. The plurality of memories may be embodied on a single computing device or may be distributed across a plurality of computing devices collectively configured to function as the apparatus 402. In various example embodiments, the memory 412 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 402 is embodied as a mobile terminal 10, the memory 412 may comprise the volatile memory 40 and/or the non-volatile memory 42. The memory 412 may be configured to store information, data, applications, instructions, or the like for enabling the apparatus 402 to carry out various functions in accordance with various example embodiments. For example, in some example embodiments, the memory 412 may be configured to buffer input data for processing by the processor 410. Additionally or alternatively, the memory 412 may be configured to store program instructions for execution by the processor 410. The memory 412 may store information in the form of static and/or dynamic information. The stored information may, for example, include messages received by the apparatus 402 and/or messages generated by the apparatus 402 for dissemination to other nodes via ad hoc communication links. This stored information may be stored and/or used by the disaster communication module 418 during the course of performing its functionalities.

The communication interface 414 may be embodied as any device or means embodied in circuitry, hardware, a computer program product comprising computer readable program instructions stored on a computer readable medium (for example, the memory 412) and executed by a processing device (for example, the processor 410), or a combination thereof that is configured to receive and/or transmit data from/to another computing device. According to some example embodiments, the communication interface 414 may be at least partially embodied as or otherwise controlled by the processor 410. In this regard, the communication interface 414 may be in communication with the processor 410, such as via a bus. The communication interface 414 may include, for example, an antenna, a transmitter, a receiver, a transceiver and/or supporting hardware or software for enabling communications with one or more remote computing devices.

The communication interface 414 may be configured to receive and/or transmit data using any protocol that may be used for communications between computing devices. In this regard, the communication interface 414 may be configured to receive and/or transmit data using any protocol that may be used for transmission of data over a wireless network, wireline network, some combination thereof, or the like by which the apparatus 402 and one or more computing devices or computing resources may be in communication. As an example, the communication interface 414 may be configured to enable communication between the apparatus 402 and one or more entities over a network, such as the network 104. As a further example, the communication interface 414 may be configured to enable establishment of an ad hoc connection, such as an ad hoc connection 108 with another node. As such, by way of non-limiting example, the communication interface 414 may accordingly be configured to provide a cellular network interface, WLAN interface, Bluetooth interface, infrared interface, near field communication interface, radio frequency communication interface, ZigBee communication interface, wireless universal serial bus (USB) communication interface, ultra wideband (UWB) communication interface, Z-Wave communication interface, and/or the like. The communication interface 414 may additionally be in communication with the memory 412, user interface 416, and/or disaster communication module 418, such as via a bus(es).

The user interface 416 may be in communication with the processor 410 to receive an indication of a user input and/or to provide an audible, visual, mechanical, or other output to a user. As such, the user interface 416 may include, for example, a keyboard, a mouse, a joystick, a display, a touch screen display, a microphone, a speaker, and/or other input/output mechanisms. In embodiments wherein the user interface 416 comprises a touch screen display, the user interface 416 may additionally be configured to detect and/or receive an indication of a touch gesture or other input to the touch screen display. In some example embodiments, such as in embodiments wherein the apparatus 402 is implemented on a peripheral device, aspects of the user interface 416 may be more limited, or the user interface 416 may even be removed. The user interface 416 may be in communication with the memory 412, communication interface 414, and/or disaster communication module 418, such as via a bus(es).

The disaster communication module 418 may be embodied as various means, such as circuitry, hardware, a computer program product comprising computer readable program instructions stored on a computer readable medium (for example, the memory 412) and executed by a processing device (for example, the processor 410), or some combination thereof and, in some example embodiments, may be embodied as or otherwise controlled by the processor 410. In embodiments wherein the disaster communication module 418 is embodied separately from the processor 410, the disaster communication module 418 may be in communication with the processor 410. The disaster communication module 418 may further be in communication with one or more of the memory 412, communication interface 414, or user interface 416, such as via a bus(es).

In some example embodiments, the disaster communication module 418 may be configured to initiate operation of a disaster communication mode by the apparatus 402. In some example embodiments, a user may provide a command input to the user interface 416 triggering activation of disaster communication mode. Accordingly, in such example embodiments, the disaster communication module 418 may be configured to initiate operation of disaster communication mode responsive to user command.

In some example embodiments, the disaster communication module 418 may be configured to initiate operation of disaster communication mode in response to network instruction. For example, a trusted network node, such as a network support apparatus 102, may suggest or command the apparatus 402 to implement disaster communication mode. In this regard, a network support apparatus 102 may, for example, determine that it has lost its connection with an outside network (for example, the Internet), that it has lost primary power and its secondary power is failing, and/or the like. In response to such a determination, the network support apparatus 102 may instruct an apparatus 402 connected to and/or within range of the network 104 (for example, nodes within the domain of the network support apparatus 102) to activate disaster communication mode.

As another example, the network support apparatus 102 may still have adequate power supply and/or may not have lost its connection with the outside world (for example, a connection to the Internet or other outside network), but may know that it is near the edge of a disaster area in which network service has been interrupted. In such an instance, the network support apparatus 102 may command nodes in its domain to activate disaster communication mode, as such nodes may travel within the disaster area and then be able to deliver/disseminate messages that the network support apparatus 102 cannot receive/deliver directly.

In embodiments wherein a network support apparatus 102 or other network node instructs an apparatus 402 to activate disaster communication mode, the disaster communication module 418 may be configured to automatically initiate operation of disaster communication mode in response to the command. Alternatively, the disaster communication module 418 may be configured to cause a user of the apparatus 402 to be notified via an output element, such as a display, speaker, and/or the like of the user interface 416 that the network has suggested that disaster communication mode be activated. If the user consents to activation of disaster communication mode, the disaster communication module 418 may initiate operation of disaster communication mode. In some example embodiments, a user setting may define whether the disaster communication module 418 first notifies a user prior to activating disaster communication mode in response to a command received from a network node.

In some example embodiments, the disaster communication module 418 may be configured to initiate operation of disaster communication mode in response to peer pressure. In this regard, for example, one or more devices that are encountered by the apparatus 402 may attempt communications based on disaster communication protocol with the apparatus 402. The disaster communication module 418 may, for example, initiate operation of disaster communication mode in response to encountering a predefined number of nodes attempting to communicate with the apparatus 402 based on disaster communication protocol. The predefined number may comprise any integer, n, that is greater than or equal to 1. In this regard, the value of the predefined number may comprise a variable setting that may be configured by a user, device manufacturer, network operator, and/or the like.

In embodiments wherein the disaster communication module 418 is configured to initiate operation of disaster communication mode in response to peer pressure, the disaster communication module 418 may be configured to automatically initiate operation of disaster communication mode automatically in response to encountering a predefined number of nodes attempting to communicate with the apparatus 402 based on disaster communication protocol. Alternatively, the disaster communication module 418 may be configured to cause a user of the apparatus 402 to be notified via an output element, such as a display, speaker, and/or the like of the user interface 416 prior to activating disaster communication mode. If the user consents to activation of disaster communication mode, the disaster communication module 418 may initiate operation of disaster communication mode. In some example embodiments, a user setting may define whether the disaster communication module 418 first notifies a user prior to activating disaster communication mode in response to a to encountering a predefined number of nodes attempting to communicate with the apparatus 402 based on disaster communication protocol.

In some example embodiments, the disaster communication module 418 may be configured to initiate operation of disaster communication mode in response to unavailability of other communications methods, such as unavailability of structured network communications. For example, in some example embodiments, the disaster communication module 418 may determine an occurrence of a disruption in network service, such as a disruption in service of the network 104, and initiate operation of disaster communication mode in response to the determination. In some such example embodiments, the disaster communication module 418 may be configured to automatically activate disaster communication mode in response to determining unavailability of network service. Alternatively, the disaster communication module 418 may prompt a user for permission prior to activating disaster communication mode.

In some example embodiments, even if user permission is generally sought prior to activating disaster communication mode, the disaster communication module 418 may be configured to automatically activate disaster communication mode without receiving user permission in an instance in which the apparatus 402 is located near (for example, within a predefined proximity) the edge of a disaster area. The disaster communication module 418 may be configured during operation of disaster communication mode to send a status message and/or determine a status of a network (for example, to determine if normal network operations have been restored) periodically (for example, every hour). If normal network operations (for example, service of the network 104) have been restored, the disaster communication module 418 may terminate operation of the disaster communication mode and return to normal operation.

In some example embodiments, if the level of a power supply (for example, a battery) powering the apparatus 402 drops below a defined threshold, the disaster communication module 418 may go into a sleep mode and/or suspend operation of disaster communication mode to preserve energy. However, the disaster communication module 418 may, in such embodiments, cause occasional activation (for example, periodic activation, activation when another node is encountered, or the like) of the apparatus 402 from sleep mode to send a message indicating that the apparatus 402 is still operation. The disaster communication module 418 may further prompt the user to confirm his/her status (for example, whether the user is OK, injured, or other status) and may include such user status information in a message sent to another node.

As the apparatus 402 may be operating on a finite power supply (for example, on battery power), some example embodiments may selectively forward messages, such as in accordance with a prioritization scheme, to encountered peer nodes in order to reduce power consumption. Such example embodiments may be further advantageous given the sometimes transient nature of ad hoc connections that may be established with encountered peer nodes, which may endure only for that period of time in which the nodes are within sufficient proximity of each other. Accordingly, an ad hoc connection may not endure for a sufficient amount of time to enable the apparatus 402 to forward all of the messages held by the apparatus 402 to an encountered node.

In this regard, some example embodiments may prioritize messages held by the apparatus 402 (for example, messages received from peers and/or messages generated by the apparatus 402) in accordance with a message prioritization scheme associated with disaster communication mode. Prioritization in some example embodiments may be based on a few assumptions of disaster communication needs. For example, it may be assumed that authorities (for example, policemen, firemen, medics, government agencies, and/or the like) have a need to know where people in a disaster area are located and to disseminate emergency status information to people in the disaster area.

Given these considerations, the disaster communication module 418 of some example embodiments may be configured to prioritize messages based at least in part on origin information included in two or more messages. Such origin information may, for example, be specified in a message header, a message frame containing the message content payload, or the like.

As one example, origin information of a message may include a generation of a message. In this regard, a generation of a respective message may denote how many times the message has been forwarded or repeated. For example, a message generated by the apparatus 402 may comprise a 0^{th} generation message, having originated at the apparatus 402. A message held by the apparatus 402 that was generated at a second node and sent from the second node to the apparatus 402 may comprise a 1^{st} generation message. A message held by the apparatus 402 that was generated at a third node, forwarded to a second node, and then forwarded from the second node to the apparatus 402 may comprise a 2^{nd} generation message, and so on. In some example embodiments, the disaster communication module 418 may be configured to prioritize a message having a lower generation over a message having a higher generation. In this regard, it may be assumed that a message having a higher generation (for example, a message that has been repeated more times) has a greater chance of having been more widely distributed within the disaster area and/or having reached an entity outside of the disaster area than a message having a lower generation.

The origin information that may be included in messages held by the apparatus 402 may additionally or alternatively comprise an indication of a message creation time. The creation time of a message may provide an indication of when the message was created. In this regard a message creation time may comprise an indication of an absolute time (for example, 12:20 Greenwich Mean Time) or may comprise another indication of when the message was created and/or how long ago the message was created. In some example embodiments, the disaster communication module 418 may be configured to prioritize a message having a more recent creation time over a message having an older creation time. In this regard, newer messages may be assumed to have more recent (for example, updated) information, which may be more valuable for forwarding. Further, it may be assumed that older messages have a greater chance of being more widely distributed within the disaster area and/or having reached an entity outside of the disaster area than a newer message.

The disaster communication module 418 may be further configured to prioritize messages based on the creator, originator, or sender of a message. For example, the disaster communication module 418 may be configured to ensure that a disproportionate number of messages created by a single entity are not prioritized over messages created by other entities. Accordingly, one entity may be inhibited from flooding communication resources within the disaster area at the expense of others.

In some example embodiments, the disaster communication module 418 may be additionally or alternatively configured to prioritize messages based at least in part on message size. For example, in some example embodiments, the disaster communication module 418 may be configured to prioritize a smaller message over a larger message. In this regard, for example, a message containing a video clip may have a large size and take up a lot of resources for transmission while providing little, if any, marginal value over a smaller message including only text content. Moreover, multiple text messages may be transmitted using the same resources (for example, transmission time, power, etc) that would be required to transmit the video message. Accordingly, in some such example embodiments, a text message having a relatively small size may be prioritized over a video message having a relatively large size.

In some example embodiments, the disaster communication module 418 may be additionally or alternatively configured to prioritize an official message over an unofficial message. In this regard, an official message may be a message intended for and/or sent by a public authority (for example, police officer, medic, fireman, government official, or other public official, a government agency or authority having jurisdiction over the disaster area, or the like), and/or the like. As appropriate authorities may have a need to disseminate status updates and instructions to individuals within a disaster area, as well as to receive information on whereabouts of individuals in a disaster area and to keep apprised on situations within the disaster area, official messages may be prioritized over unofficial messages.

As the apparatus 402 may be operating on a battery or other finite power source and alternative power supplies may not be available to recharge the battery during a disaster, the disaster communication module 418 may be configured to implement more restrictive prioritization policies as the energy from a power source used by the apparatus 402 is drained. For example, when power remaining reaches a predefined threshold, the disaster communication module 418 may refuse to send and/or receive messages greater than a threshold size. As another example, when power remaining reaches a predefined threshold, the disaster communication module 418 may refuse to send and/or receive messages older than a threshold creation time and/or that are of a generation higher than a threshold generation. The disaster communication module 418 may also cause the apparatus 402 to hibernate for periods of time (for example, periodically or aperiodically) to conserve power. However, the disaster communication module 418 may be configured to exit hibernation in response to determining the apparatus 402 has come within proximity of another node.

It will be appreciated that in various example embodiments, the disaster communication module 418 may be configured to prioritize messages based on any combination of one or more of the previously discussed prioritization criteria and/or other prioritization criteria.

In response to encountering another node (for example, coming within sufficient proximity of another node to establish an ad hoc connection), such as a node 106, the disaster communication module 418 may be configured to cause establishment of an ad hoc connection. The type of ad hoc connection established between the apparatus 402 and a proximate node may be selected based on common communications capabilities shared by the apparatus 402 and the proximate node. For example, if the apparatus 402 and proximate node are both Bluetooth capable, a Bluetooth connection may be established. In some example embodiments, establishment of an ad hoc connection and communication of messages over the ad hoc connection between an apparatus 402 and proximate node may be performed automatically without user input in response to the apparatus 402 coming within sufficient proximity of the node to establish an ad hoc connection.

In embodiments wherein messages held by the apparatus 402 have been prioritized, the disaster communication module 418 may be configured to select a message based at least in part on the prioritization, and cause the selected message to be sent to the node via the ad hoc connection. It will be appreciated that the proximate node to which a selected message is sent need not be the designated (for example, by the original creator of the message) as the intended recipient of the selected message. In this regard, some example embodiments provide for peer-to-peer, or swarm, forwarding of messages to increase chances of messages reaching parties outside of a disaster area and/or of being disseminated within the disaster area.

In embodiments wherein a message includes origin information indicating a generation of the message, the disaster communication module 418 may be configured to increment the generation counter prior to sending a message to a proximate node. Alternatively, in some example embodiments rather than the generation counter being incremented prior to transmission of a message, the generation counter may be incremented by the disaster communication module 418 associated with an apparatus 402 receiving the message from a proximate node. In some example embodiments, the disaster communication module 418 associated with a sending node and the disaster communication module 418 associated with a receiving node may negotiate whether the generation counter is to be incremented prior to the message being sent by the sending node or by the receiving node after receipt of the message. This negotiation may, for example, occur after establishment of a connection between the sending and receiving nodes.

The disaster communication module 418 may be configured to continue to select a next highest priority message and forward the next highest priority message to the proximate node so long as the proximate node is within sufficient proximity. In this regard, in some example embodiments, the disaster communication module 418 may forward as many messages as possible in order of priority to a node while that node is within sufficient proximity of the apparatus 402.

A proximate node may also forward messages to the apparatus 402 in accordance with disaster communication mode. If an ad hoc connection supports two-way (or multi-way) data transfer, the apparatus 402 and proximate node may forward messages concurrently. Alternatively, nodes communicating over an ad hoc connection may implement a round robin or other sharing of the ad hoc connection, taking turns in sending messages. For example, each node may be allowed to forward a defined number of messages or a defined amount of data before ceding its turn to the next node.

In some example embodiments, the disaster communication module 418 may be configured to determine whether a proximate node has already received a message prior to sending the message to the proximate node. In this regard, such example embodiments may conserve resources by avoiding forwarding duplicate messages to nodes. In some such example embodiments, the disaster communication module 418 may be configured to determine whether a proximate node has previously received a message by sending the proximate node an identifier of a message selected for transmission to the proximate node. The identifier may comprise a checksum of the message or other identifier that may uniquely identify the message. The proximate node (for example, a disaster communication module that may be implemented on the proximate node) may compare the received identifier to those of messages held by the proximate node and, based on the comparison, may respond to the apparatus 402 with an indication of whether the node has or has not previously received the message. If the message has not been previously received by the proximate node, the disaster communication module 418 associated with the apparatus 402 may send the message to the proximate node. If, however, the proximate node has previously received the message, the disaster communication module 418 may skip sending the message, and may, for example, select the next highest priority message for sending to the proximate node.

In some example embodiments a message payload may be unencrypted and observable to every node in a swarm. However, in some example embodiments, messages transmitted in disaster communication mode may be at least partially encrypted. For example, a creator of a message may encrypt a message with a public key associated with an intended recipient. Thus, while the message may be held and forwarded by several nodes in a swarm, unless the intended recipient's private key has been compromised, only the ultimate intended recipient may be able to decrypt the message. For example, a message intended for an authority may be encrypted with the public key of the authority. Upon receiving the message, the authority may use its private key to decrypt the message.

As another example, a payload of a message may be encrypted with a first public key, and subsequently, the entire message may be encrypted with a second public key. The first public key may correspond to a private key possessed by an intended recipient, while the second public key may correspond to a private key possessed by an authority or other intermediary (for example, an entity outside of the disaster area) that may receive a message originating from the disaster area and rout the message to its ultimate intended recipient. Accordingly, the intermediary may decrypt the message to reveal the forwarding address of the ultimate intended recipient. The intermediary may further forward the message, including the still encrypted payload, to the forwarding address of the intended recipient. The intended recipient may be able to decrypt the payload using its private key. However, swarm nodes encountering the message within the disaster area may not be able to decrypt either the payload or the destination address of the message.

In some example embodiments, official messages sent by an authority may be encrypted so as to enable verification by a receiving apparatus 402 that a message purporting to be official was actually sent by the authority, and not by a nefarious third party. In this regard, an authority disseminating a message may at least partially encrypt the message with the authority's private key. A receiving apparatus 402 may have and/or obtain a copy of the corresponding public key of the authority, and may use the public key to verify the authenticity of the message by decrypting the encrypted portion of the message.

In the event that the apparatus 402 receives an official message created by an authority from a proximate node, the disaster communication module 418 may be configured in some example embodiments to provide notification to a user of the apparatus 402. Accordingly, the user may be apprised of updates, instructions, and/or other information that may be received in official messages.

In some example embodiments, the disaster communication module 418 may prioritize messages held by the apparatus 402 based at least in part on an encryption status of the messages. For example, an unencrypted message may be prioritized over an encrypted message. In this regard, it is possible that unencrypted messages may be tampered with by other users. Accordingly, delivery of unencrypted messages may be prioritized in some example embodiments to improve the possibility that an unmodified version of the message is ultimately delivered outside of the disaster area and/or to its intended recipient. In some such example embodiments, the disaster communication module 418 may refuse to forward encrypted messages and/or may refuse to forward encrypted messages if a remaining power level is below a defined threshold, as there may be a greater chance that an unmodified version of the encrypted message has been delivered outside of the disaster area and/or to its intended recipient.

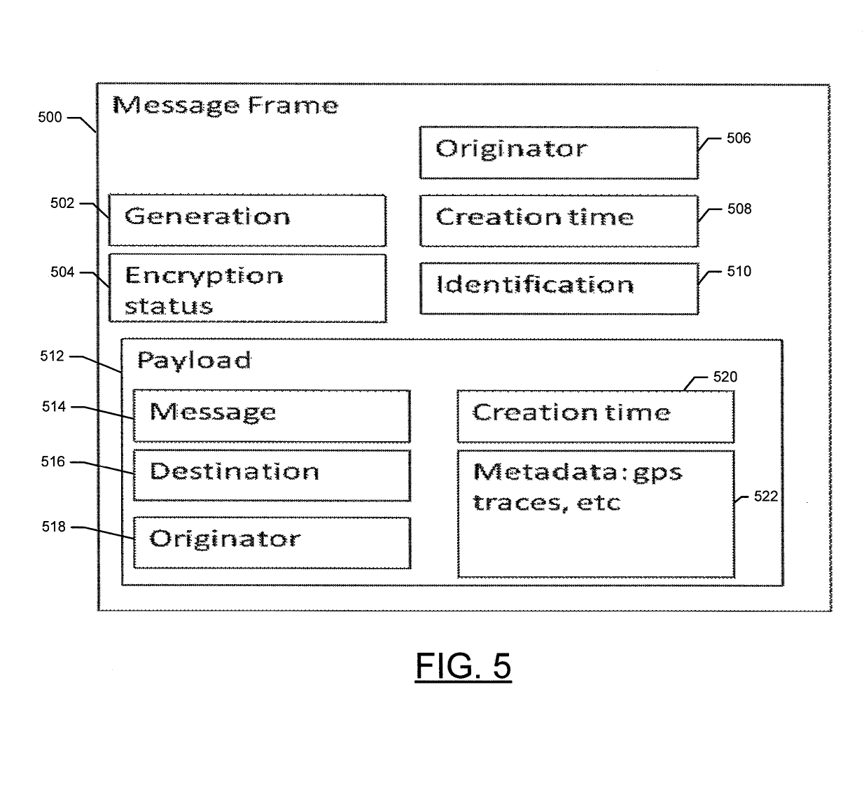

FIG. 5 illustrates an example message format that may be created, sent, and/or received by nodes operating in disaster communication mode according to some example embodiments. The illustrated message format may comprise a message frame 500, which may include both a series of information fields, such as one or more of the fields 502-510, and the message payload 512. The generation field 502 may indicate how many times the message has been forwarded among swarm nodes, and may accordingly be incremented each time the message is forwarded from one peer node to another peer node. The encryption status field 504 may indicate whether the message, or portion thereof, such as the payload 512, is encrypted. The Originator field 506 may indicate which node or user originated the message, and may be in human readable format. The creation time field 508 may indicate when the message was created.

If the message, or at least the generation field 502 and creation time field 508, is unencrypted, the generation field 502 and/or creation time field 508 may be reset to increase the prioritization of the message to allow for wider distribution. For example a user may find a message to be important, or otherwise interesting, and may reset the fields to increase the prioritization of the message.

The identification field 510 may comprise a unique string, checksum, or other identifier that may identify the message. The identifier may be assigned randomly. If the identifier is a string or other value, it may be selected such that it is long enough to be unlikely to appear a second time. In this regard, the contents of the identification field 510 may be used by the disaster communication module 418 when determining whether a message has already been received.

Some fields from the frame 500, such as the originator field 506 and creation time field 508 may be repeated in the payload portion 512, as illustrated by the example originator field 518 and creation time field 520, respectively. In this regard, if the payload 512 is encrypted, the repeated fields may ensure that original field values remain even if the corresponding unencrypted fields of the frame are modified prior to the message arriving at its intended recipient. The message field 514 of the payload 512 may include the actual data contents of the message. The destination field 516 may indicate the intended recipient of the message. In some example embodiments, the destination field 516 may only be used if the message is not intended for receipt by the authorities. The field 522 may include various metadata that may be associated with the message, such as Global Positioning System (GPS) traces. The message field 514 may optionally repeat the payload field structure in a recursive manner so as to enable the originator to hide the true destination of the message from the swarm nodes.

In some example embodiments, the disaster communication module 418 may be configured to determine when the apparatus 402 reaches the edge (for example, within a defined threshold distance of the edge) of the disaster area and/or establishes communications outside of the disaster area, such as through a structured network that might otherwise be used by the apparatus 402. In such example embodiments, the disaster communication module 418 may be configured to cause one or more messages held by the apparatus 402 to be sent outside of the disaster area.

For example, the disaster communication module 418 may be configured to cause one or more messages held by the apparatus 402 to be sent to a network node designated by an authority for receipt of disaster communications in response to determining that the apparatus 402 has established communications outside of the disaster area. For example, the disaster communication module 418 may dump all of the disaster communications to the designated network node. Authorities may decrypt the messages sent to the designated network node to glean information about the disaster. For example, the authorities may use message fields and/or metadata containing information on message sender, location, creation time, and/or the like to establish conditions within the disaster area. Distress messages, messages to friends and family, and/or the like may be forwarded by the authorities to their intended recipients.

Additionally or alternatively, the disaster communication module 418 may be configured to deliver some messages held by the apparatus 402 to their intended recipients in response to the apparatus 402 establishing communications outside of the disaster area. Whether the disaster communication module 418 delivers a message to its intended recipient may be predicated on the cost of delivery of the message. For example, sending a thousand MMS messages collected from peer nodes in the disaster area to their intended destinations may be prohibitively expensive. However, forwarding one or more emails collected from peer nodes in the disaster area to their intended recipients may not be cost prohibitive.

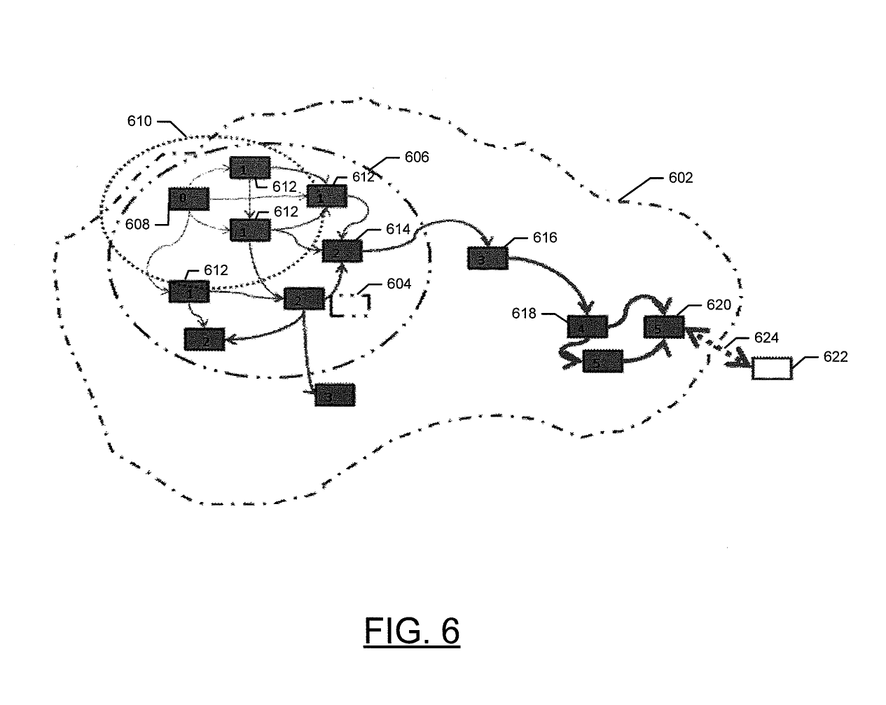

Referring now to FIG. 6, an example disaster communication scenario in accordance with some example embodiments is illustrated. In this regard, FIG. 6 illustrates a disaster area 602, in which network service may be disrupted. Within the disaster area 602, an access support apparatus 604 may serve an area 606. In response, to the disaster, the access support apparatus 604 may instruct all nodes (for example, the node 608 and nodes 612) within its domain area 606 to initiate disaster communication mode.

It will be noted that in the example illustration of FIG. 6, all nodes represented by solid-filled rectangles are operating in disaster communications mode. The numbers within the solid-filled rectangles indicate the generation of a message as it travels among the nodes, as will be described further below.

The node 608 may generate a message, and send the message to all nodes 612 within the range 610 which the node 608 may reach via ad hoc connections. While at node 608 this message is a 0^{th} generation message. When the message reaches the nodes 612, it becomes a 1^{st} generation message for those nodes. The nodes 612 may forward the message to various second generation nodes, such as the node 614 that they come within proximity. However, the nodes 612 may not exchange the message among themselves, as they already have the message. If the nodes 612 have any messages of their own, they may be prioritized over the message received from the node 608, as such messages would be 0^{th} generation messages for the nodes 612.

The node 614 may travel within proximity of the node 616, to which the node 614 may forward the message create by the node 608, at which point the message may become a third generation message. The node 616 may, in turn come within proximity of the node 618 and forward the message to the node 618, at which point it may become a fourth generation message. The node 618 may subsequently come within proximity of the node 620 and forward the message to the node 620, at which point it may become a fifth generation message.

The node 620 may be able to establish communications beyond the disaster area 602, and may forward the message, as well as other messages held by the node 620, to the node 622, which may be designated by an authority for receipt of disaster communications. The node 622 may also inject official messages into the ad hoc network within the disaster area, as indicated by the two-headed arrow 624. The node 622 may, for example, comprise a base station of a portion of a cellular network not affected by the disaster.

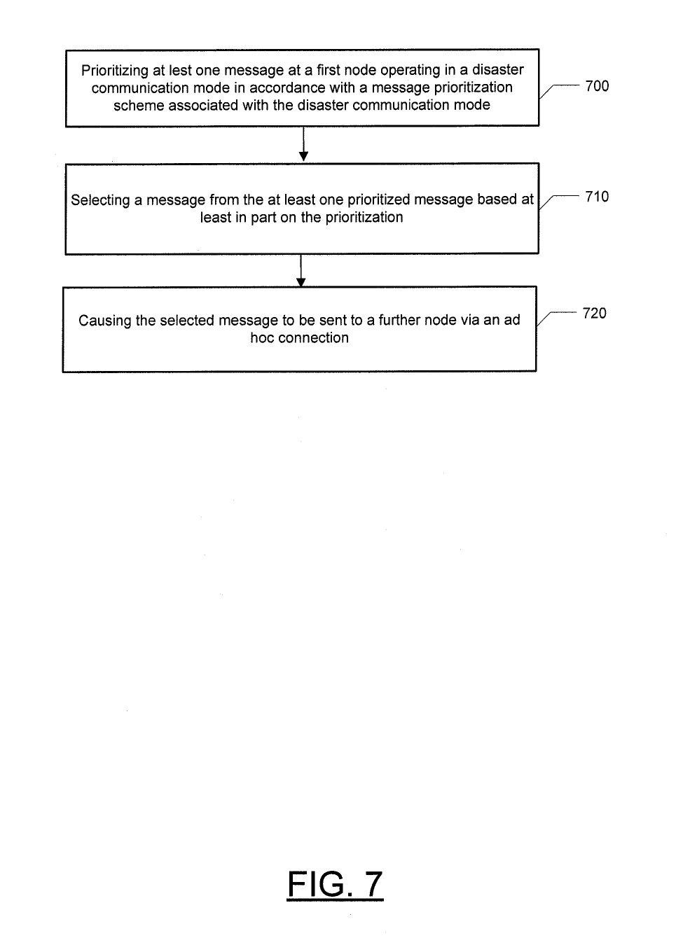

FIG. 7 illustrates a flowchart according to an example method for facilitating disaster communications according to some example embodiments. In this regard, FIG. 7 illustrates operations that may be performed at the apparatus 402. The operations illustrated in and described with respect to FIG. 7 may, for example, be performed by, with the assistance of, and/or under the control of one or more of the processor 410, memory 412, communication interface 414, user interface 416, or disaster communication module 418. Operation 700 may comprise prioritizing at least one message at a first node operating in a disaster communication mode in accordance with a message prioritization scheme associated with the disaster communication mode. The processor 410, memory 412, and/or disaster communication module 418 may, for example, provide means for performing operation 700. Operation 710 may comprise selecting a message from the at least one prioritized message based at least in part on the prioritization. The processor 410, memory 412, and/or disaster communication module 418 may, for example, provide means for performing operation 710. Operation 720 may comprise causing the selected message to be sent to a further node via an ad hoc connection. The processor 410, memory 412, communication interface 414, and/or disaster communication module 418 may, for example, provide means for performing operation 720.

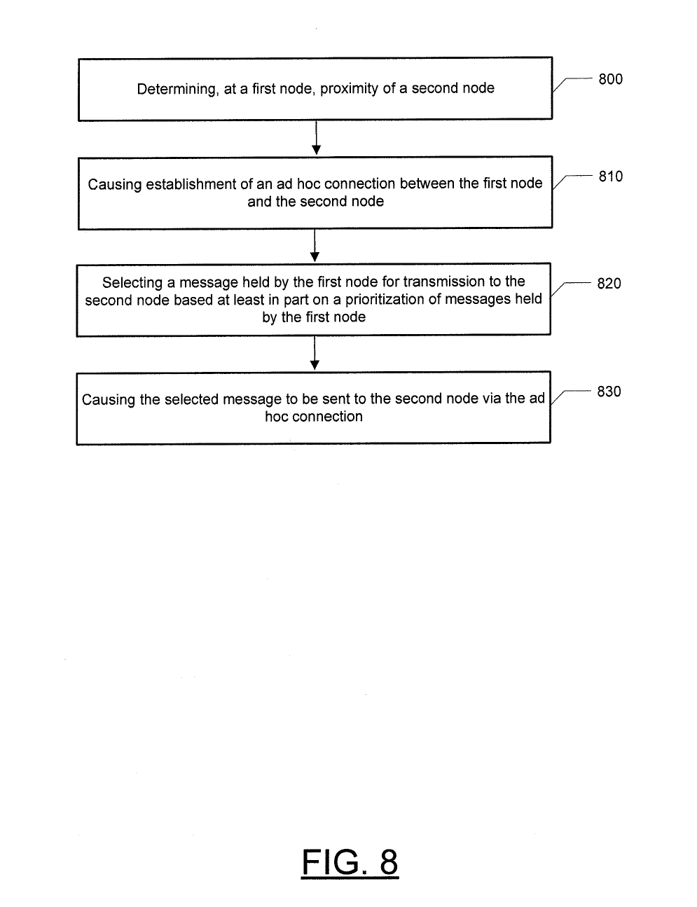

FIG. 8 illustrates a flowchart according to another example method for facilitating disaster communications according to some example embodiments. In this regard, FIG. 8 illustrates operations that may be performed at the apparatus 402. The operations illustrated in and described with respect to FIG. 8 may, for example, be performed by, with the assistance of, and/or under the control of one or more of the processor 410, memory 412, communication interface 414, user interface 416, or disaster communication module 418. Operation 800 may comprise determining, at a first node, proximity of a second node. Such determination may, for example, be made in response to receipt of a signal, such as a Bluetooth inquiry, a response to a Bluetooth inquiry, or the like that may be emitted by the second node. The processor 410, memory 412, communication interface 414, and/or disaster communication module 418 may, for example, provide means for performing operation 800. Operation 810 may comprise causing establishment of an ad hoc connection with the second node in response to the second node being in proximity of the first node. The processor 410, memory 412, communication interface 414, and/or disaster communication module 418 may, for example, provide means for performing operation 810. Operation 820 may comprise selecting a message held by the first node for transmission to the second node based at least in part on a prioritization of messages held by the first node. The processor 410, memory 412, and/or disaster communication module 418 may, for example, provide means for performing operation 820. Operation 830 may comprise causing the selected message to be sent to the second node via the ad hoc connection. The processor 410, memory 412, communication interface 414, and/or disaster communication module 418 may, for example, provide means for performing operation 830. In some example embodiments, one or more of operations 810-830 may be performed automatically without user input in response to the first node coming within proximity of the second node.

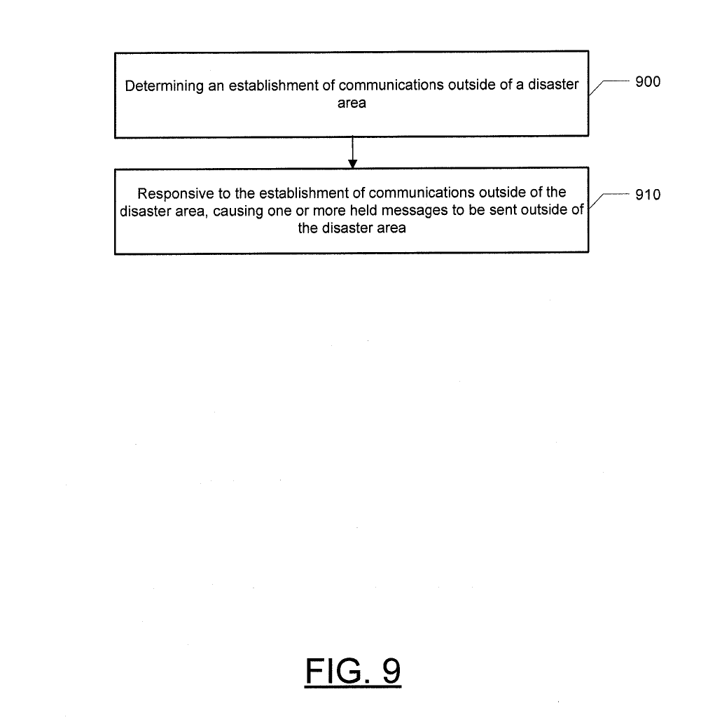

FIG. 9 illustrates a flowchart according to yet another example method for facilitating disaster communications according to some example embodiments. In this regard, FIG. 9 illustrates operations that may be performed at the apparatus 402. The operations illustrated in and described with respect to FIG. 9 may, for example, be performed by, with the assistance of, and/or under the control of one or more of the processor 410, memory 412, communication interface 414, user interface 416, or disaster communication module 418. Operation 900 may comprise determining an establishment of communications outside of a disaster area. The processor 410, memory 412, communication interface 414, and/or disaster communication module 418 may, for example, provide means for performing operation 900. Operation 910 may comprise, responsive to the establishment of communications outside of the disaster area, causing one or more held messages to be sent outside of the disaster area. The processor 410, memory 412, communication interface 414, and/or disaster communication module 418 may, for example, provide means for performing operation 910.

FIGS. 7-9 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 412) and executed by a processor in the computing device (for example, by the processor 410). In some example embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 402) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, an apparatus 402) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. According to some example embodiments, a suitably configured processor (for example, the processor 410) may provide all or a portion of the elements. In other example embodiments, all or a portion of the elements may be configured by and operate under control of a computer program product. The computer program product for performing the methods of some example embodiments may include a computer-readable storage medium (for example, the memory 412), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1-37. (canceled)

38. A method comprising:
prioritizing at least one message at a first node operating in a disaster communication mode in accordance with a message prioritization scheme associated with the disaster communication mode;
selecting a message from the at least one prioritized message based at least in part on the prioritization; and
causing the selected message to be sent to a further node via an ad hoc connection.

39. The method of claim 38, wherein causing the selected message to be sent comprises causing the prioritized message to be sent in response to the first node being within sufficient proximity of the further node to establish the ad hoc connection.

40. The method of claim 38, wherein the further node is not designated by the selected message as an intended recipient of the selected message.

41. The method of claim 38, wherein prioritizing the at least one message in accordance with the message prioritization scheme comprises prioritizing the at least one message based at least in part on origin information included in each respective message of the at least one message.

42. The method of claim 38, wherein prioritizing the at least one message in accordance with the message prioritization scheme comprises prioritizing the at least one message based at least in part on message size.

43. The method of claim 38, wherein prioritizing the at least one message in accordance with the message prioritization scheme comprises prioritizing an official message over an unofficial message.

44. The method of claim 38, further comprising:
determining an establishment of communications outside of a disaster area; and
responsive to the establishment of communications outside of the disaster area, causing at least one of the prioritized messages to be sent outside of the disaster area.

45. The method of claim 44, wherein causing the at least one of the prioritized messages to be sent outside of the disaster area comprises causing a message to be sent to a network node designated by an authority for receipt of disaster communications.

46. The method of claim 38, further comprising initiating the operation of the disaster communication mode at the first node in response to network instruction.

47. An apparatus comprising at least one processor and at least one memory storing computer program code, wherein the at least one memory and stored computer program code are configured, with the at least one processor, to cause the apparatus to at least:
prioritize at least one message, while operating in a disaster communication mode, in accordance with a message prioritization scheme associated with the disaster communication mode;
select a message from the at least one prioritized message based at least in part on the prioritization; and
cause the selected message to be sent to at least one node via an ad hoc connection.

48. The apparatus of claim 47, wherein the at least one memory and stored computer program code are configured, with the at least one processor, to cause the apparatus to cause the selected message to be sent at least in part by causing the prioritized message to be sent in response to the apparatus being within sufficient proximity of the at least one node to establish the ad hoc connection.

49. The apparatus of claim 47, wherein the at least one node is not designated by the selected message as an intended recipient of the selected message.

50. The apparatus of claim 47, wherein the at least one memory and stored computer program code are configured, with the at least one processor, to cause the apparatus to prioritize the at least one message in accordance with the message prioritization scheme at least in part by prioritizing the at least one message based at least in part on origin information included in each respective message of the at least one message.

51. The apparatus of claim 50, wherein the origin information included in a respective message comprises an indication of a generation of the respective message, and wherein the at least one memory and stored computer program code are configured, with the at least one processor, to cause the apparatus to prioritize the at least one message at least in part by prioritizing a message having a lower generation over a message having a higher generation.

52. The apparatus of claim 47, wherein the at least one memory and stored computer program code are configured, with the at least one processor, to cause the apparatus to prioritize the at least one message at least in part by prioritizing an official message over an unofficial message.

53. The apparatus of claim 47, wherein the at least one memory and stored computer program code are configured, with the at least one processor, to further cause the apparatus to increment a generation counter included in the selected message prior to causing the selected message to be sent.

54. The apparatus of claim 47, wherein the at least one memory and stored computer program code are configured, with the at least one processor, to further cause the apparatus to:
determine an establishment of communications outside of a disaster area; and
responsive to the establishment of communications outside of the disaster area, cause at least one of the prioritized messages to be sent outside of the disaster area.

55. The apparatus of claim 54, wherein the at least one memory and stored computer program code are configured, with the at least one processor, to cause the apparatus to cause the at least one of the prioritized messages to be sent outside of the disaster area at least in part by causing a message to be sent to a network node designated by an authority for receipt of disaster communications.

56. The apparatus of claim 47, wherein the at least one memory and stored computer program code are configured, with the at least one processor, to further cause the apparatus to initiate the operation of the disaster communication mode in response to a network instruction.

57. The apparatus of claim 47, wherein the at least one memory and stored computer program code are configured, with the at least one processor, to further cause the apparatus to initiate the operation of the disaster communication mode in response to a predefined number of other nodes attempting to communicate with the apparatus based on the disaster communications protocol.
